(19) United States
(12) Patent Application Publication
(10) Pub. No.: US 2012/0125735 A1
(43) Pub. Date: May 24, 2012

(54) VERTICAL ACTION SORTER AND METHOD OF SORTING ARTICLES

(75) Inventors: Dennis J. Schuitema, Ada, MI (US); Paul L. Wetters, Rockford, MI (US); Kenneth J. Kooistra, Byron Center, MI (US)

(73) Assignee: DEMATIC CORP., Grand Rapids, MI (US)

(21) Appl. No.: 13/302,566

(22) Filed: Nov. 22, 2011

Related U.S. Application Data
(60) Provisional application No. 61/416,845, filed on Nov. 24, 2010.

(51) Int. Cl. B65G 47/46

(52) U.S. Cl. 198/370.04; 198/348

(57) ABSTRACT

A vertical action sorter is provided along a transport conveyor for selectively diverting articles from the conveyor to a different location, such as a bin or another conveyor. Each sorter includes a sorter module that is selectively raised and lowered in response to an actuator, such as a linear actuator, that drives actuator members along respective tracks associated with the sorter module. Each track includes a contoured surface that controls the rate at which the sorter module will be raised and lowered in response to the linear actuator. A cross member may be provided for evenly supporting the sorter module as it is raised and lowered.

### CROSS REFERENCE TO RELATED APPLICATION

The present application claims the benefit of U.S. provisional application, Ser. No. 61/416,845, filed Nov. 24, 2010, which is hereby incorporated herein by reference in its entirety.

### FIELD OF THE INVENTION

The present invention relates generally to conveyors and, more particularly, to conveyors capable of sorting articles.

### BACKGROUND OF THE INVENTION

Conveyors for transporting articles are sometimes equipped with sorters having one or more diverters that can divert certain articles off from a main conveyor line to provide a sorting function. For example, articles may be diverted off of a main conveyor line to one side or another, or may be diverted up or down to a higher or lower elevation than the main conveyor line.

### SUMMARY OF THE INVENTION

The present invention provides a vertical action sorter for a conveyor system, the sorter being capable of selectively diverting selected articles to a discharge location at a higher or lower elevation, such as to a bin, a chute, or a separate conveyor line. The vertical action sorter includes a sorter module that is mounted to a side frame and is capable of being raised or lowered by an actuator. The actuator moves an actuator member, such as a roller bearing, along a contoured support track associated with the sorter module, in order to raise or lower the module. The sorter module is thus positionable between a raised position and a lowered position via engagement of the moving actuator member with the support track associated with the sorter module. The shape of the contoured support track affects the precise manner in which the sorter module moves in response to movement of the actuator member along the support track.

According to one aspect of the invention, a vertical action sorter includes at least one side frame, a sorter module, a support track, an actuator member for engaging the support track, and a linear actuator for moving the actuator member along the support track. The sorter module, which has a conveying surface, an intake end, a discharge end, and left and right side portions, is movably supported by the side frame and is operable to selectively discharge articles at either of an upper discharge location in a raised position, and a lower discharge location in a lowered position. The support track is mounted at either the sorter module or the side frame, and has a track surface with a shape that affects the acceleration of the sorter module. The actuator member is coupled to the other of the sorter module and the side frame, and is movable between first and second positions along the track surface. The linear actuator is coupled between the actuator member and the side frame, and is operable to move the actuator member along the track surface. The sorter module is movable to the raised position by the linear actuator moving the actuator member along the track surface to the first position, for discharging articles at the upper discharge location. The sorter module is also movable to the lowered position by the linear actuator moving the actuator member along the track surface to the second position, for discharging the articles at the lower discharge location.

The vertical action sorter may include a rack-and-pinion arrangement in which an actuator member is mounted at each end of a movable cross member having a longitudinal axis that is generally perpendicular to the side frame. The cross member further includes pinion gears at opposite end portions of the cross member, for intermeshing engagement with respective toothed racks positioned along respective side frames on each of the left and right sides of the sorter module. The linear actuator is coupled to the cross member near one of the pinion gears. Both pinion gears turn with the cross member, so that as the linear actuator extends and retracts, it drives both pinion gears simultaneously. Thus, the entire movable cross member moves in a synchronized manner so that the left and right actuator members move together along the respective left and right support tracks, and so that the sorter module moves evenly between the raised and lowered positions.

According to another aspect of the invention, a vertical action sorter includes at least one side frame, a plurality of sorter modules, and an endless drive belt. Each of the sorter modules includes a conveying surface, an intake end, a driven roller at the intake end, and a discharge end, and is pivotably supported by the side frame. The sorter modules are operable to selectively discharge articles at either an upper discharge location or a lower discharge location. The conveying surfaces of the sorter modules are operable to convey articles along the sorter or to divert articles off of the sorter at the discharge ends of the sorter modules. The endless drive belt is supported at the side frame and is driven by a drive motor. The drive belt is operable to continuously and simultaneously drive the driven rollers of the sorter modules, regardless of whether the sorter modules are positioned to discharge articles at the upper discharge location or the lower discharge location.

According to another aspect of the invention, a vertical action sorter includes at least one side frame, a sorter module, left and right support tracks, a movable cross member having left and right actuator members at its left and right ends, and a linear actuator. The sorter module includes conveying surface, an intake end, a discharge end, and left and right side portions, and is movably supported by the side frame between raised and lowered positions. The sorter module is operable to selectively discharge articles at either of an upper discharge location corresponding to the raised position, and a lower discharge location corresponding to the lowered position. The left support track is arranged at the left portion of the sorter module and has a left contoured surface. The right support track is arranged at the right portion of the sorter module, and has a right contoured surface. The movable cross member is positioned below the sorter module, and has a longitudinal axis that is generally perpendicular to the side frame. The left actuator member is in movable engagement with the left contoured track surface, and the right actuator member in movable engagement with the right contoured track surface. The left and right actuator members are movable between first and second positions along the respective left and right contoured track surfaces. The linear actuator is coupled between the movable cross member and the side frame, and is operable to move the left and right actuator members simultaneously along the respective left and right contoured track surfaces between the first and second positions. The cross member is movable in a direction that is perpendicular to the longitudinal axis, and is movable substantially without changing the orientation of the longitudinal axis, so that the left and right actuator members move along the respective left and right contoured track surfaces in a synchronized manner. The sorter module is movable to its raised position by the linear actuator moving the left and right actuator members simultaneously along the track surfaces to the first position for discharging articles at the upper discharge location, and the sorter module is movable to the lowered position by the linear actuator moving the left and right actuator members simultaneously along the track surfaces to the second position for discharging the articles at the lower discharge location.

According to still another aspect of the present invention, a method is provided for vertically sorting articles on a conveyor. The method includes positioning a sorter module at a side frame, the sorter module having a support track with contoured track surface, and at least one driven pulley operable to convey articles along a conveying surface of the sorter module, from an intake end to a discharge end thereof. The sorter module is pivotable between a raised position and a lowered position to raise and lower at least the discharge end of the sorter module. A linear actuator is coupled between the side frame and a movable actuator member that contacts the contoured track surface of the support track. An article is conveyed along the conveying surface from the intake end toward the discharge end. Before the article reaches the discharge end of the sorter module, the linear actuator is actuated to move the actuator member from a first position along the contoured track surface to a second position along the contoured surface, to thereby lower the discharge end of the sorter module. The article is discharged from the discharge end of the sorter module while the sorter module is at the lowered position.

Thus, a sorting apparatus and method are provided for discharging articles in at least two different discharge locations, each having a different elevation. The sorter module can be evenly actuated on both sides of the module with a single linear actuator located on only one side of the module, by providing a movable cross member on which the actuator members are mounted, and including a pair of pinion gears that engage respective toothed racks on opposite side frames.

These and other objects, advantages, purposes, and features of the present invention will become apparent upon review of the following specification in conjunction with the drawings.

### BRIEF DESCRIPTION OF THE DRAWINGS

FIG. 1 is a perspective view of a transport conveyor having a pair of adjacent vertical action sorter modules in accordance with the present invention, the sorter modules positioned at their lowered positions;

FIG. 2 is an enlarged perspective view of a portion of the transport conveyor of FIG. 1, with one side frame removed for clarity;

FIG. 3 is another perspective view of the opposite side of one of the vertical action sorter modules of FIG. 1;

FIG. 4 is a side elevation of the sorter modules of FIG. 1, with portions of the conveyor removed for clarity;

FIG. 5 is an end sectional elevation of a sorter module;

FIG. 6 is an enlarged view of the area designated VI in FIG. 4;

FIG. 7 is a perspective view of the intake end of a sorter module in a raised position;

FIG. 8 is a perspective view of the intake end of a sorter module in a lowered position;

FIG. 9 is a side elevation of the sorter module of FIG. 8, with portions of the conveyor removed for clarity; and

FIG. 10 is a sectional view of a cross member of the vertical action sorter.

### DESCRIPTION OF THE PREFERRED EMBODIMENTS

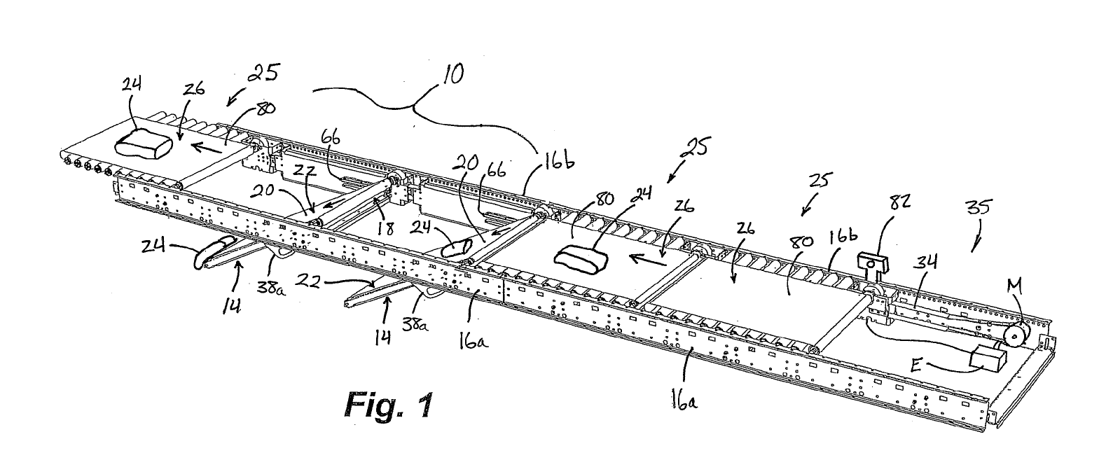

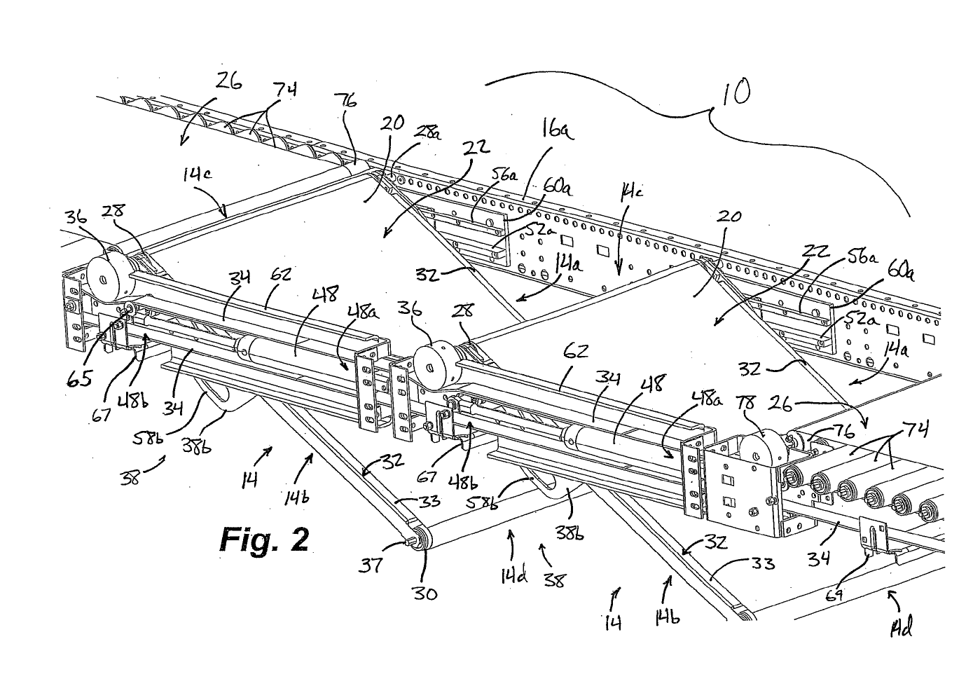

Referring now to the drawings and the illustrative embodiments and depicted therein, a vertical action sorter 10 for a conveyor system 12 includes one or more pivotally-mounted sorter modules 14 coupled between a pair of left and right side frame members 16a, 16b and arranged in tandem (FIG. 1). Sorter modules 14 have respective left side portions 14a, right side portions 14b, intake ends 14c, and discharge ends 14d (FIG. 2). In the illustrated embodiment, each sorter module 14 includes a pair of spaced rollers having a belt 20 reeved over the rollers, the belt 20 defining a conveying surface 22. Conveyor system 12 may further include a plurality of transport zones 25 located upstream and downstream of sorter modules 14. Transport zones 25 define transport or conveying surfaces 26 for feeding articles to sorter 10 and/or for taking articles 24 away from sorter 10. Sorter modules 14 selectively divert articles 24 as they are conveyed onto conveying surfaces 22 from a transport surface 26 of an upstream transport zone 25, or from an upstream conveying surface 22. Sorter modules 14 are independently operable to raise and lower in response to a control signal so that selected articles 24 can be discharged off of conveyor system 12 at a different elevation. Vertical action sorter 10 and conveyor system 12 may be particularly well-suited to transporting and sorting soft or non-rigid particles or packages, such as bagged clothing articles, bagged hardware, or even loose, unpackaged articles. However, the sorter and conveyor system may be used to sort other types of articles as well.

Each sorter module 14 includes a driven roller or pulley or sheave 28 at intake end 14c, and an idler roller or pulley or sheave 30 at discharge end 14d. Each roller 28, 30 is coupled to a frame 32 having a belt support 33. In the illustrated embodiment, belt support 33 is a slider plate that supports belt 20 as it passes between the rollers 28, 30. Optionally, the belt support may include a plurality of idler rollers between driven roller 28 and idler roller 30 for supporting belt 20. Driven roller 28 is rotatably coupled between left side frame member 16a and right side frame member 16b, and is rotatably driven by a drive system 35 that includes an endless drive belt 34 (FIGS. 1 and 2) that frictionally engages a drum 36 coupled to the right end portion of driven roller 28. Drive belt 34 is driven by a motor M (FIG. 1). Each, idler roller 30 is mounted to frame 32 via an axle 37. In the illustrated embodiment, when sorter module 14 is placed in a raised position, discharge end 14d of sorter module 14 is generally supported in a cantilever manner, i.e., with the full weight of sorter module 14 supported at or near its intake end 14c.

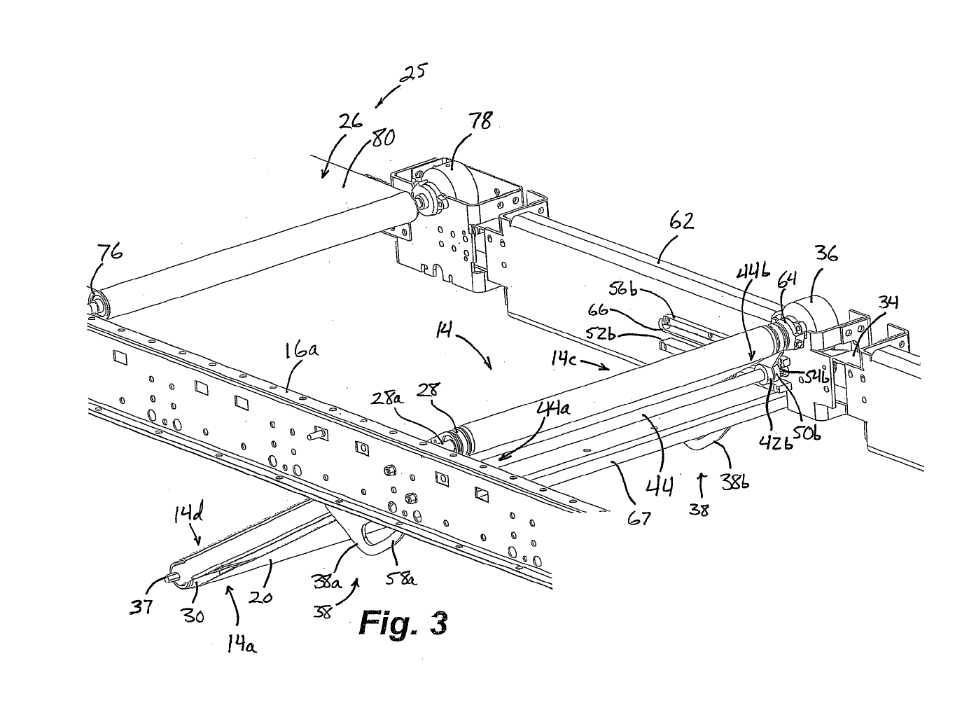

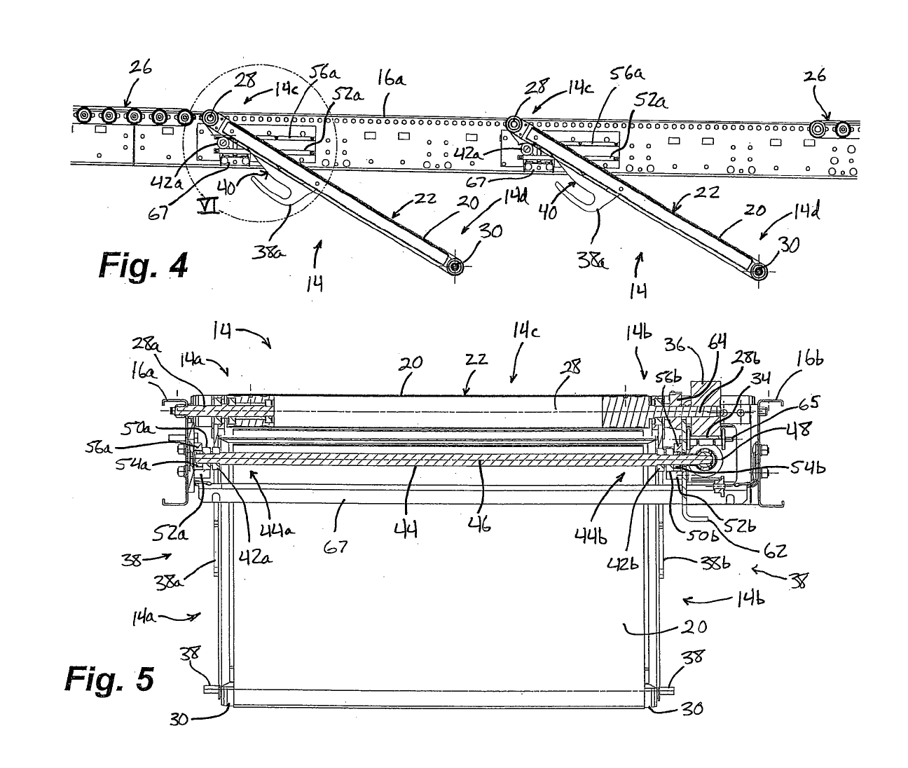

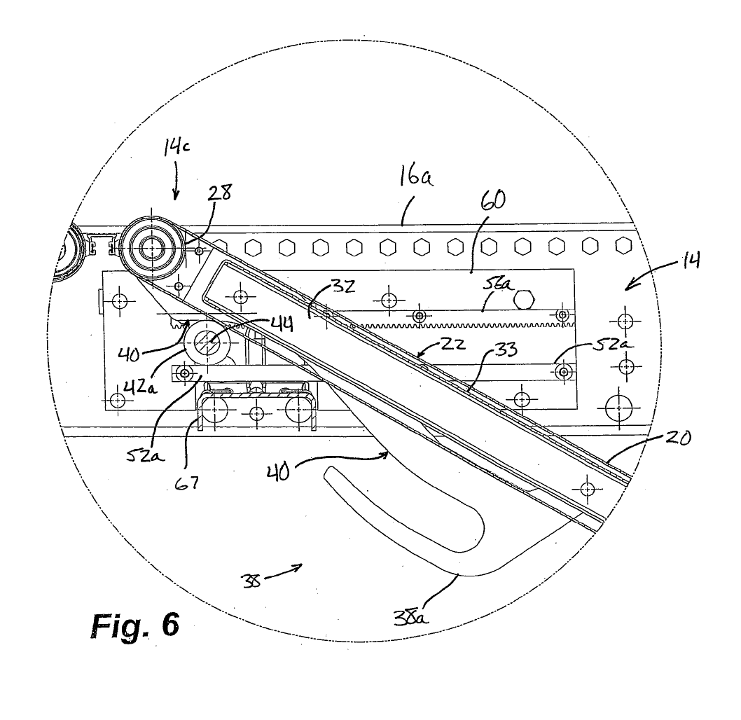

Each sorter module 14 further includes a support track system 38 that, in the illustrated embodiment, is made up of a pair of support tracks 38a, 38b corresponding to the respective left and right side portions 14a, 14b of the module. Each support track 38a, 38b defines a generally downwardly-facing contoured or curved surface 40 (FIGS. 4 and 6-9) that is engaged by a respective actuator member such as a roller or bearing 42a, 42b, which is mounted at a respective left or right end portion 44a, 44b of a movable cross member 44 (FIGS. 3-10).

Movable cross member 44 has a longitudinal axis 46 (FIG. 5) that is substantially perpendicular to side frame members 16a, 16b, with left end portion 44a and right end portion 44b positioned near the respective right and left side frame members 16a, 16b. Cross member 44 is movable in a direction transverse to longitudinal axis 46, and in the illustrated embodiment, is movable along a substantially linear, horizontal path. A powered linear actuator 48 urges cross member 44 along its path, and includes a cylinder 48a coupled to right side frame member 16b, and an extendible piston rod 48b coupled to right end portion 44b of cross member 44 (FIG. 2). Right end portion 44b of movable cross member 44 is rotatably coupled to piston rod 48b of linear actuator 48, so that cross member 44 can rotate relative to linear actuator 48 as the linear actuator extends and retracts. Linear actuator 48 may be a pneumatic, hydraulic, or electrically powered actuator that extends and retracts in response to an electrical signal and/or a pressurized fluid, for example. Linear actuator 48 may extend and retract its piston rod 48b at a substantially constant speed, or may be controlled to accelerate and decelerate to provide different rates of raising or lowering of the sorter module 14.

Cross member 44 is supported at its respective ends by left and right side frame members 16a, 16b. Cross member 44 has support bearings 50a, 50b positioned at the left end portion 44a and right end portion 44b of cross member 44, respectively, with support bearings 50a, 50b located outboard of the respective left and right actuator bearings 42a, 42b. Support bearings 50a, 50b are supported on respective horizontal tracks 52a, 52b, which are coupled to respective side frame members 16a, 16b (FIGS. 4-8). Left and right pinion gear assemblies 53a, 53b each include pinion gears 54a, 54b and toothed racks 56a, 56b. Pinion gears 54a, 54b may be positioned outboard of each support bearing 50a, 50b. Each pinion gear is fixedly attached to a respective end portion 44a, 44b of cross member 44 so that pinion gears 54a, 54b both rotate with cross member 44 about longitudinal axis 46. In contrast, support bearings 50a, 50b and actuator bearings 42a, 42b are rotatable with respect to cross member 44 and pinion gears 54a, 54b. Toothed racks 56a, 56b may be positioned above and substantially parallel to each horizontal track 52a, 52b, and is coupled to a respective side frame member 16a, 16b (FIGS. 2-9). Each toothed rack 56a, 56b engages and intermeshes with a respective one of pinion gears 54a, 54b.

As cross member 44 is moved horizontally in a direction perpendicular to its longitudinal axis 46, the intermeshing engagement of pinion gears 54a, 54b with toothed racks 56a, 56b forces both pinion gears 54a, 54b and cross member 44 to rotate together in response to extension or retraction of piston rod 48b of linear actuator 48. Thus, pinion gears 54a, 54b enable cross member 44 to maintain its alignment (i.e., to remain perpendicular to both side frame members 16a, 16b) as it translates relative to the side frame members, even though cross member 44 is actuated only by linear actuator 48 coupled to the cross member's right end portion 44b. This is because the linear movement of right end portion 44b, caused by actuator 48, is converted into rotation of cross member 44 due to the meshing engagement of right pinion gear 54b with right toothed rack 56b. This in turn causes left pinion gear 54a to rotate at the same speed as cross member 44 and right pinion gear 54b, so that left pinion gear 54a translates with right pinion gear 54b. Thus, left end portion 44a of cross member 44 translates horizontally at the same speed or rate as right end portion 44b.

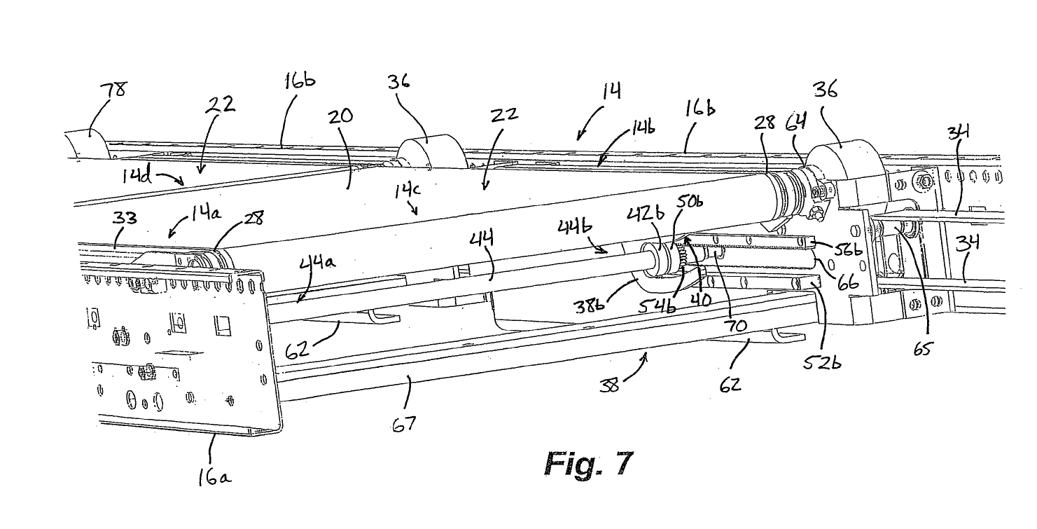

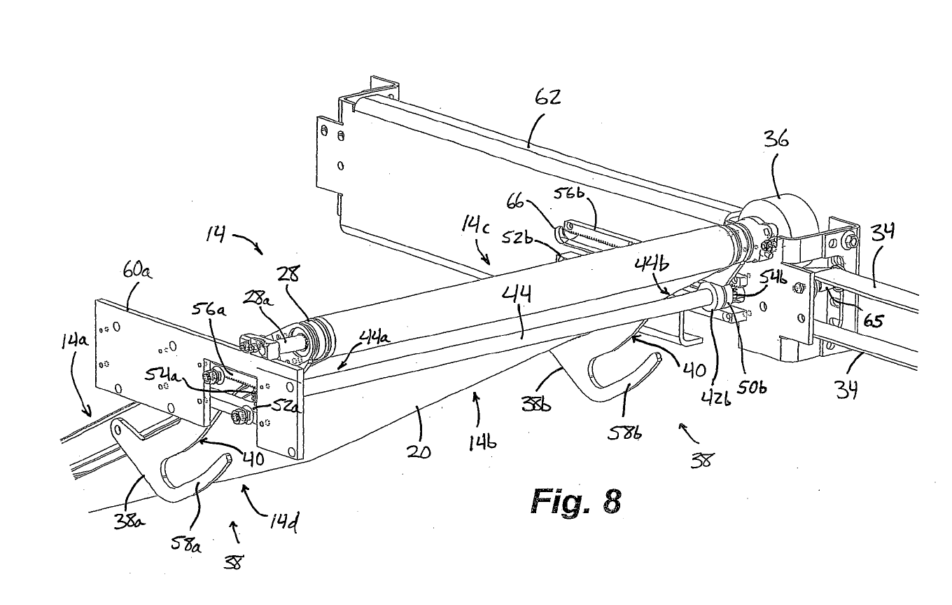

Referring to FIG. 2, left horizontal track 52a and left toothed rack 56a may be coupled to a mounting plate 60 that is in turn coupled to left side frame member 16a with mechanical fasteners. Cross member 44 is movable between a first position in which piston rod 48b of actuator 48 is retracted and sorter module 14 is in it raised position (FIG. 7), and a second position in which piston rod 48b is extended and sorter module 14 is in its lowered position (FIGS. 2 and 8). As linear actuator 48 extends and retracts its piston rod 48b, support bearings 50a, 50b roll along their respective horizontal tracks 52a, 52b, while actuator bearings 42a, 42b roll along the contoured track surfaces 40 of the respective support tracks 38a, 38b. Support tracks 38a, 38b are substantially identical to each other, or are mirror images of one another, so that each support track is engaged by a respective actuator bearing in a synchronized manner. This allows sorter module 14 to be evenly raised and lowered in response to extension and retraction of actuator 48.

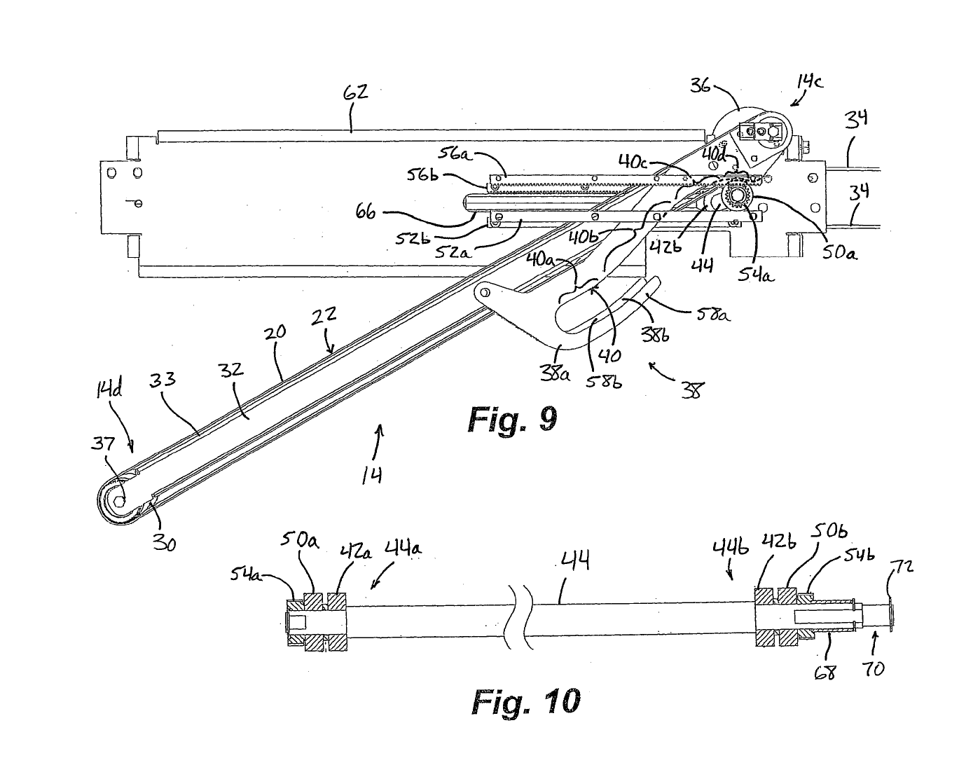

It will be appreciated by those skilled in the art that the profile or shape of contoured track surface 40 can be selected in a manner that affects the rate at which sorter module 14 pivots upwardly or downwardly as actuator bearings 42a, 42b traverse or roll along the respective support tracks 38a, 38b. For example, and with reference to FIG. 9, contoured track surface 40 includes a first region 40a that is generally parallel to conveying surface 22. Actuator bearings 42a, 42b are located in first region 40a when the actuator bearings are in their first position, as shown in FIG. 7. Because first region 40a is generally parallel to conveying surface 22, and is engaged by actuator bearings 42a, 42b when the sorter module is in a raised or horizontal position, the pivotal orientation of sorter module 14 changes little as actuator bearings 42a, 42b traverse first region 40a. This prevents an abrupt drop of discharge end 14d of sorter module 14 and conveying surface 22 as actuator bearings 42a, 42b are initially moved out of their first position by linear actuator 48. A second region 40b of contoured track surface 40 slopes upwardly as it approaches intake end 14c of sorter module 14, which allows sorter module 14 to pivot downwardly toward its lowered position of FIG. 9.

It will be appreciated by those skilled in the art that the slope of second region 40b may be increased to increase the rate at which sorter module 14 pivots as actuator bearings 42a, 42b traverse second region 40b. The contour of each transition from one region of the track surface 40 to another, and the slope of each track surface region, affects the rate of pivotal acceleration of sorter module 14 as actuator bearings 42a, 42b transition from first region 40a to second region 40b of contoured track surface 40. It will further be appreciated that the speed at which actuator bearings 42a, 42b are moved along contoured track surface 40 will also affect the sorter module's pivot speed and acceleration.

A third region 40c of contoured track surface 40 transitions from the slope of second region 40b to a fourth region 40d that is closest to intake end 14c of sorter module 14. Fourth region 40d is substantially horizontal when sorter module 14 is in its lowered position (FIG. 9) so that the sorter module halts its pivoting motion as it reaches the lowered position once actuator bearings 42a, 42b reach fourth region 40d of contoured track surface 40. Third region 40c gradually transitions from the relatively steep slope of second region 40b (which corresponds to a relatively high rate of pivotal motion of sorter module 14) to the lower or zero-slope fourth region 40d, so that the downward pivoting motion of sorter module 14 gradually decelerates to a stop as actuator bearings 42a, 42b traverse third region 40c into fourth region 40d. As in the transition between first region 40a and second region 40b, the smoothness of the change in slope along the transitional third region 40c affects the rate of deceleration of the downward pivotal motion of sorter module 14 until the downward pivotal motion stops entirely as actuator bearings 42a, 42b reach their second position in fourth region 40d.

Conversely, as linear actuator 48 retracts its piston rod 48b to move actuator bearings 42a, 42b out of their second position of FIG. 9 (i.e., along fourth region 40d), and toward their first position of FIG. 7 (i.e., toward first region 40a), the rate of change of the slope of contoured track surface 40 in third region 40c affects the rate of upward pivotal acceleration of sorter module 14. The upward pivotal rate of sorter module 14 reaches a maximum as actuator bearings 42a, 42b traverse second region 40b with the greatest slope. The upward pivotal motion of sorter module 14 then decelerates as it reaches its raised position, as actuator bearings 42a, 42b reach and transition along first region 40a until bearings 42a, 42b once again reach their first position of FIG. 7, in which sorter module 14 is again fully raised and parallel to transport surfaces 26 of conveyor system 12.

In the illustrated embodiment, support tracks 38a, 38b each include a respective lower extension portion 58a, 58b (FIGS. 8 and 9) that is spaced below and arranged substantially parallel to first region 40a of contoured track surfaces 40. The upper surfaces of lower extension portions 58a, 58b are spaced from contoured track surface 40 by a distance that is approximately equal to, or slightly greater than, the diameter of actuator bearings 42a, 42b. Thus, lower extension portions 58a, 58b may not be engaged by actuator bearings 42a, 42b during normal operation of sorter module 14. Lower extension portions 58a, 58b prevent lift-off or disengagement of actuator bearings 42a, 42b from track surfaces 40 in the event that linear actuator 48 is actuated too quickly in moving actuator bearings 42a, 42b along second region 40b of contoured track surface 40 as sorter module 14 is pivoted upwardly from its lowered position (i.e., while moving actuator bearings 42a, 42b from their second position to their first position). Thus, lower extension portions 58a, 58b guard against the separation of actuator bearings 42a, 42b from contoured track surface 40 along first region 40a, and at least a portion of second region 40b. The use of lower extension portions 58a, 58b may also permit sorter module 14 to be pivoted upwardly at a faster rater than would otherwise be achievable, by entrapping actuator bearings 42a, 42b and preventing lift-off of track surfaces as the actuator bearings traverse the area from second region 40b from first region 40a.

Although the support tracks are shown and described herein as being coupled to the sorter modules for movement with the modules between a raised horizontal position and a downwardly-pivoted or lowered position, it will be appreciated that numerous variations are envisioned without departing from the spirit and scope of the present invention. For example, the sorter modules may be made to pivot between a lowered horizontal position and an upwardly-pivoted raised position for discharging articles at a raised elevation, simply by changing the shape of the contoured surfaces of the support tracks. Optionally, the sorter modules could be raised and lowered in a level and horizontal manner, substantially without pivoting, such as by using motorized drive rollers and a pair of support tracks arranged longitudinally on each side of the sorter module, with corresponding actuator bearings engaging all of the tracks simultaneously. Optionally, the support tracks could be fixedly coupled to respective left and right side frame members, with linear actuators coupled to the sorting modules for pivotal movement with the modules, to achieve pivotal movement of the sorting modules as described above.

Cylinder 48a of linear actuator 48 is mounted to a support bracket 62, and piston rod 48b is extendable and retractable relative to cylinder 48a. Piston rod 48b is connected to right end portion 44b of movable cross member 44. A part of right end portion 44b of movable cross member 44 extends through a slot 66 in support bracket, and traverses the slot 66 as the cross member 44 travels horizontally in response to extension and retraction of the piston rod 48b of linear actuator 48 (FIGS. 1, 3, 7, and 8).

In the illustrated embodiment, piston rod 48b of actuator 48 is coupled to cross member 44 at a position spaced outboard of pinion gear 54b, on the opposite side of slot 66 in support bracket 62. Optionally, a bushing 68 (FIGS. 7 and 10) is provided along right end portion 44b of cross member 44, outboard of pinion gear 54b. Bushing 68 has a diameter that is approximately equal to the height of slot 66 so that it engages the upper and/or lower surfaces of support bracket 62 that defines slot 66. Bushing 68 facilitates the smooth movement of cross member 44 and also provides a replaceable wear surface along cross member 44. Outboard of bushing 68, along right end portion 44b of cross member 44, is a reduced-diameter coupling region 70 to which piston rod 48b of linear actuator 48 is coupled and retained by a removable retaining clip 72 (FIG. 10) that engages a groove near the outboard end of coupling region 70.

Driven roller 28 is rotatably supported by left side frame member 16a via engagement of a left roller spindle or axle 28a that extends through an opening in side frame member 16a, above mounting plate 60 (FIGS. 2 and 8). Along the right side of conveyor system 12, support bracket 62 is coupled to right side frame member 16b on an inboard side thereof. Support bracket 62 houses and supports drive belt 34, actuator 48, and other portions of vertical action sorter 10, as best shown in FIG. 2. Driven roller 28 includes a right side driven axle 28b (FIG. 5) that turns with roller 28, and a left axle 28a that is non-rotatably coupled to left side frame member 16a. Left axle 28a is supported inside of driven roller 28 via bearings so that roller 28 can rotate relative to left axle 28a. Driven axle 28b extends through an opening in support bracket 62, and is supported at a bearing 64 that is itself coupled to support bracket 62 (FIG. 5). The outboard end portion of driven axle 28b is fixedly coupled to drum 36, so that driven axle 28b (and driven roller 28) rotate with drum 36. Side frame members 16a, 16b are coupled together at spaced intervals by cross members 67 positioned below each driven roller 28 (FIGS. 2-7), with additional cross members 69 positioned at spaced intervals along transport zones 25 (FIG. 2).

Drum 36 is frictionally engaged by drive belt 34 at the drum's lower surface (FIG. 2). A pair of rotatable sheaves or spindles 65, which are rotatably coupled to support bracket 62, are positioned at least slightly above the bottom portion of drum 36 to maintain the frictional engagement of drive belt 34 with drum 36 (FIGS. 2, 5 and 8). Drive belt 34 is an endless belt that is driven by motor M (FIG. 1) and frictionally engages drums 36 of sorter modules 14 to rotatably drive rollers 28, regardless of the pivotal orientation of each sorter module 14. Drive belt 34 may also rotatably drive the transport zones 25 of conveyor system 12, in substantially an identical manner as with sorter modules 14. Suitable drive belts are available, for example, from Nitta Corp. of America, of Suwanee, Ga. In the illustrated embodiment, transport zones 25 each include a plurality of idler rollers 74 and a driven roller 76 at the upstream end, each driven roller 76 being rotatably drivable by a drum 78 that is frictionally contacted and driven by drive belt 34 in substantially the same manner as the drums 36 that are associated with the driven rollers 28 of sorter modules 14 (FIG. 2). Each transport zone 25 includes an endless belt 80 reeved around idler rollers 74 and driven rollers 76, the belt 80 defining transport surface 26.

It will be appreciated that driven roller 28 of sorter module 14, and driven roller 76 of transport zone 25, may each be rotatably driven using other mechanisms or methods, such as by configuring the driven rollers as motorized rollers, as is known in the art, or with a belt drive system such as that described in commonly-assigned U.S. patent application Ser. No. 12/891,868, filed Sep. 28, 2010 and entitled “Belt Drive Conveyor with a Power Tap Off,” which is hereby incorporated herein by reference in its entirety. Such systems also allow multiple transport zones and/or sorter modules to be driven by a single belt.

Although conveyor system 12 is shown and described as being generally level or horizontal in orientation, with drive rollers for conveying articles along the transport surfaces and conveying surfaces, it will be appreciated that the principles of the present invention may be applied to conveyors having sloped or non-horizontal transport surfaces and/or conveying surfaces. Further, these principles may be applied to a gravity conveyor whereby slider plates would typically be replaced with idler rollers, and articles would be conveyed along the idler rollers of the transport zones and the sorter modules by gravity. In a gravity conveyor arrangement, the articles would generally move downwardly along the slope of the transport conveyor while moving along the conveyor and being selectively diverted off the conveyor at the sorter modules, also by gravity.

Conveyor system 12 may include an article sensor in the form of at least one photo eye 82 (FIG. 1) at an upstream end to determine the location and spacing of article 24 along the conveyor, and this information may be conveyed to a controller. The controller logs the time at which an article 24 passed photo eye 82, calculates the time at which the article 24 will arrive at a given sorter module 14, based on a signal received from an encoder E that senses the belt speed, and may itself be driven at the same speed as belt 34 by motor M, which also drives belt 34 (FIG. 1). Encoder E signals linear actuator 48 to move sorter module 14 to its lowered position once the article 24 is on that module's conveying surface 22. Actuator 48 accomplishes this by retracting its piston rod 48b to move cross member and actuator bearings 42a, 42b from the first position (in which the sorter module 14 is in its raised position) toward the second position (in which sorter module 14 will be in its lowered position for diverting articles off of conveyor 12). Because the sorter module belts 20 and transport surfaces 26 travel at the same speed, the controller can also calculate when an article being diverted has left the discharge end 14d of a given sorter module 14, and then signal the linear actuator 48 to extend its piston rod 48b to thereby move cross member 44 and actuator bearings 42a, 42b back to the first position to thereby raise sorter module 14 so that conveying surface 22 is once again substantially coplanar with transport surfaces 26. Belts 20 (and also the belts forming transport surfaces 26) may exhibit a low modulus characteristic of the type disclosed in commonly-assigned U.S. Pat. Nos. 6,811,018; 7,093,709; and 7,556,144, all of which are hereby incorporated herein by reference in their entireties. Optionally, an upstream zone or module may be provided to space articles discharged to conveyor system 12 at desired intervals to facilitate sorting. For example, conveyors that are capable of spacing articles at desired intervals are described in commonly-assigned U.S. Pat. No. 7,806,254, entitled “Belt Conveyor and Method,” which is hereby incorporated herein by reference in its entirety.

Optionally, the downward pivoting motion of sorter module 14 may be initiated while an article not being diverted is still at least partially supported at discharge end 14d of sorter module 14, as that article is transitioning to the intake end of a subsequent sorter module or transport zone. Similarly, once a sorter module 14 that is in its lowered position is about to discharge an article from its discharge end 14d, the controller may signal the linear actuator 48 to begin extending its piston rod 48b to raise the sorter module 14. The discharging article will still be discharged by the movement of belt 20, even as the sorter module 14 is being raised. A sorter module 14 in its lowered position may also receive or accept an article that will not be discharged, even while the module is in its lowered position, as long as sorter module 14 will be returned to its raised position by the time the article reaches discharge end 14d. Thus, articles that are being conveyed along conveyor system 12, and selectively discharged from one or more sorter modules 14, may be spaced in a manner such that one article being discharged by a given sorter module occupies the conveying surface 22 simultaneously with an upstream article that is not to be discharged. This is because the sorter module 14 will be raised back to substantially the same plane as transport surfaces 26 by the time the non-discharging article reaches discharge end 14d of a sorter module 14.

Accordingly, conveyor system 12 is operable to transport articles 24, while selectively discharging selected ones of the articles at the vertical action sorter 10, which includes one or more sorter modules 14. The sorter modules 14 are raised and lowered via a single linear actuator 48. The use of a single actuator, while not required to carry out all aspects of the present invention, avoids the difficulty and service requirements of synchronizing the simultaneous actuation of a pair of linear actuators, while still providing even support and synchronized movement of a pivotable sorter module using a rack-and-pinion arrangement on either side of the sorter module. This results in reduced complexity and cost, reduced service requirements, and consistent performance of the sorter module.

Changes and modifications in the specifically described embodiments may be carried out without departing from the principles of the present invention, which is intended to be limited only by the scope of the appended claims, as interpreted according to the principles of patent law including the doctrine of equivalents.

The embodiments of the invention in which an exclusive property or privilege is claimed are defined as follows:

1. A vertical action sorter comprising:
at least one side frame;
a sorter module movably supported by said at least one side frame and operable to selectively discharge articles at (i) an upper discharge location when in a raised position, and (ii) a lower discharge location when in a lower position, said sorter module having a conveying surface, an intake end, a discharge end, and left and right side portions;
a support track at one of said sorter module and said at least one side frame, said support track having a track surface with a track surface shape;
an actuator member coupled to the other of said sorter module and said at least one side frame, said actuator member engaging said track surface of said support track and being movable between first and second positions along said track surface;
a linear actuator coupled to said actuator member, said linear actuator operable to move said actuator member along said track surface between said first and second positions; and
wherein said sorter module is movable to said raised position by said linear actuator moving said actuator member along said track surface to said first position for discharging articles at the upper discharge location, said sorter module is movable to said lowered position by said linear actuator moving said actuator member along said track surface to said second position for discharging the articles at the lower discharge location, and wherein the shape of said track surface affects the acceleration of said sorter module as it moves between said raised position and said lowered position.

2. The vertical action sorter of claim 1, wherein said support track is mounted on said sorter module, said linear actuator is mounted on said at least one side frame, and said actuator member is coupled to said at least one side frame via said linear actuator.

3. The vertical action sorter of claim 1, wherein said track surface comprises a contoured non-linear track surface.

4. The vertical action sorter claim 1, wherein said at least one side frame comprises left and right side frames, said left side frame supporting said left side portion of said sorter module and said right side frame supporting said right side portion of said sorter module.

5. The vertical action sorter of claim 4, wherein said support track comprises a left support track at said left side portion of said sorter module, and a right support track at said right side portion of said sorter module, and said actuator member comprises left and right actuator members engaging respective ones of said left and right support tracks, each of said left and right support tracks comprising a contoured track surface that is engaged by a respective one of said left and right actuator members in a sliding or rolling manner.

6. The vertical action sorter of claim 5, further comprising:
left and right toothed racks, each of said toothed racks disposed along a respective one of said left and right side frames;
a movable cross member disposed below said sorter module, said movable cross member having left and right end portions and a longitudinal axis that is generally perpendicular to each of said left and right side frames;
said left and right actuator members coupled to said left and right end portions of said movable cross member;
left and right pinion gears coupled to said left and right end portions of said movable cross member near said left and right actuator members, respectively, each of said pinion gears configured to intermesh with a respective one of said left and right toothed racks; and
wherein said left and right pinion gears are non-rotatably coupled to said movable cross member so that rotation of one of said left and right pinion gears causes rotation of said movable cross member and the other of said left and right pinion gears.

7. The vertical action sorter of claim 6, wherein said linear actuator is coupled to one of said left and right end portions of said cross member and is operable to move said cross member in a direction that is perpendicular to said longitudinal axis, substantially without changing the orientation of said longitudinal axis, so that said left and right actuator members move along said left and right track surfaces in a substantially synchronized manner.

8. The vertical action sorter of claim 1, wherein said sorter module is pivotably mounted to said at least one side frame so that said intake end maintains a substantially constant elevation as said discharge end is raised and lowered to move said sorter module between said raised and lowered positions.

9. The vertical action sorter of claim 1, wherein said sorter module comprises at least one driven pulley operable to convey articles along said sorter module from said intake end to said discharge end.

10. The vertical action sorter of claim 9, further comprising a drive belt operable to rotatably drive said driven pulley.

11. The vertical action sorter of claim 1, wherein said conveying surface comprises one chosen from a belt and a plurality of rollers.

12. The vertical action sorter of claim 1, wherein said linear actuator comprises one chosen from (i) a hydraulic actuator, (ii) an electrical actuator, and (iii) a pneumatic actuator.

13. A vertical action sorter comprising:
at least one side frame;
a plurality of sorter modules arranged in tandem, each of said sorter modules pivotably supported by said at least one side frame and operable to selectively discharge articles at either of an upper discharge location and a lower discharge location, said sorter module having a conveying surface, an intake end, a driven roller at said intake end, and a discharge end, said conveying surface for selectively conveying articles along the vertical action sorter and diverting articles off of the vertical action sorter at said discharge end of said sorter module;
an endless drive belt supported at said at least one side frame, and a drive for driving said drive belt, said endless drive belt being operable to continuously drive said driven rollers of said sorter modules when said sorter module is positioned to discharge articles at the upper discharge location and when said sorter module is positioned to discharge articles at the lower discharge location.

14. The vertical action sorter of claim 13, further comprising at least one upstream transport zone positioned upstream of said sorter modules and at least one downstream transport zone positioned downstream of said sorter modules, each of said transport zones supported by said at least one side frame and having a respective transport surface, an intake end for conveying articles along the vertical action sorter, and a driven roller.

15. The vertical action sorter of claim 14, further comprising:
a drum at one end of said driven roller of each of said sorter modules;
a drum at one end of said driven roller of each of said transport zones; and
wherein said drums of said driven rollers of said transport zones are generally aligned with said drums of said driven rollers of said sorter modules.

16. The vertical action sorter of claim 15, wherein said endless drive belt is operable to frictionally engage said drums of said driven rollers of said sorter modules and said transport zones to rotatably drive each of said driven rollers.

17. The vertical action sorter of claim 14, wherein at least one of said conveying surfaces and said transport surfaces comprises a conveyor belt.

18. The vertical action sorter of claim 14, wherein said driven rollers of said sorter modules have respective axes of rotation, and wherein said sorter modules are pivotable about said axes of rotation of said driven rollers.

19. The vertical action sorter of claim 14, wherein when said sorter modules are in said raised position, said conveying surfaces and said transport surfaces are substantially coplanar.

20. The vertical action sorter of claim 14, further comprising:
an article sensor at an upstream end of said sorter for sensing articles supplied to said sorter; and
an encoder for tracking movement of articles along said conveying surfaces of said sorter modules.

21. A vertical action sorter comprising:
at least one side frame;
a sorter module movably supported by said at least one side frame and operable to selectively discharge articles at either of an upper discharge location and a lower discharge location, said sorter module having a conveying surface, an intake end, a discharge end, and left and right side portions;
a left support track at said left portion of said sorter module, said left support track having a left contoured surface, and a right support track at said right portion of said sorter module, said right support track having a right contoured surface;
a movable cross member disposed below said sorter module, said movable cross member having left and right end portions and a longitudinal axis that is generally perpendicular to said at least one side frame;
a left actuator member in movable engagement with said left contoured track surface, and a right actuator member in movable engagement with said right contoured track surface, each of said left and right actuator members coupled to a respective one of said left and right end portions of said movable cross member, wherein said left and right actuator members are movable between first and second positions along said respective left and right contoured track surfaces;
a linear actuator coupled between said movable cross member and said at least one side frame, said linear actuator operable to move said left and right actuator members simultaneously along said respective left and right contoured track surfaces between said first and second positions, wherein said cross member is movable in a direction that is perpendicular to said longitudinal axis and is movable substantially without changing the orientation of said longitudinal axis, so that said left and right actuator members move along said respective left and right contoured track surfaces in a synchronized manner; and
wherein said sorter module is movable to a raised position by said linear actuator moving said left and right actuator members simultaneously along said track surfaces to said first position for discharging articles at the upper discharge location, said sorter module is movable to a lowered position by said linear actuator moving said left and right actuator members simultaneously along said track surfaces to said second position for discharging the articles at the lower discharge location.

22. The vertical action sorter of claim 20, wherein said at least one side frame comprises left and right side frames, and said vertical action sorter comprises rack-and-pinion gear assemblies between said end portions of said moveable cross member and said side frames to cause said actuator members to move in a synchronized manner.

23. The vertical action sorter of claim 22, wherein said rack-and-pinion gear assemblies comprise:
a left toothed rack disposed along said left side frame, and a right toothed rack disposed along said left side frame;
a left pinion gear coupled to said left end portion of said movable cross member, and a right pinion gear coupled to said right end portion of said movable cross member, each of said left and right pinion gears configured to intermesh respectively with said left and right toothed racks; and
wherein said left and right pinion gears are non-rotatably coupled to said movable cross member so that rotation of one of said left and right pinion gears causes rotation of said movable cross member and the other of said left and right pinion gears.

24. The vertical action sorter of claim 23, further comprising:
a left track fixedly coupled to said left side frame, and a right track fixedly coupled to said right side frame;
a left support bearing rotatably coupled to said left end portion of said movable cross member, and a right support bearing rotatably coupled to said right end portion of said movable cross member, each of said left and right support bearings movably supported along said respective left and right tracks; and
wherein said left and right support bearings are configured to roll along said respective left and right tracks to support said movable cross member as it moves between said first and second positions.

25. A method of sorting articles on a conveyor, said method comprising:
positioning a sorter module at a side frame, said sorter module having a conveying surface, an intake end, a discharge end, and a support track having a contoured track surface, said sorter module comprising at least one driven pulley operable to convey articles along said conveying surface from said intake end to said discharge end, said sorter module being pivotable between a raised position and a lowered position to raise and lower at least said discharge end of said sorter module;
coupling a linear actuator between said at least one side frame and a movable actuator member that is in supportive contact with said contoured track surface of said support track;
conveying an article along said conveying surface from said intake end toward said discharge end;
before the article reaches said discharge end of said sorter module, actuating said linear actuator to move said actuator member from a first position along said contoured track surface to a second position along said contoured surface to pivot said sorter module by lowering at least said discharge end of said sorter module; and
discharging the article from said discharge end of said sorter module while said sorter module is at said lowered position.
